(19) United States
(12) Patent Application Publication
(10) Pub. No.: US 2025/0105951 A1
(43) Pub. Date: Mar. 27, 2025

(54) FLUSHING HYBRID AUTOMATIC REPEAT REQUEST BUFFERS IN A MULTIPLE TRANSMISSION RECEPTION POINT CONFIGURATION

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Shaozhen GUO, Beijing (CN); Tao LUO, San Diego, CA (US); Xiaoxia ZHANG, San Diego, CA (US); Peter GAAL, San Diego, CA (US); Junyi LI, Greentown, PA (US)

(21) Appl. No.: 18/728,305

(22) PCT Filed: Mar. 10, 2022
(86) PCT No.: PCT/CN2022/080072

§ 371 Date: Jul. 11, 2024

(51) Int. Cl. H04L 1/1867; H04W 76/38

(52) U.S. Cl. CPC H04L 1/1896; H04W 76/38

(57) ABSTRACT

Various aspects of the present disclosure generally relate to wireless communication. In some aspects, a user equipment (UE) may receive, from a network entity, a configuration that indicates a time alignment timer associated with a timing advance group (TAG) for a bandwidth part (BWP) or a component carrier (CC) configured for multiple downlink control information (multi-DCI) based multiple transmission reception point (multi-TRP) communications. The UE may start the time alignment timer for a TRP. The UE may flush one or more hybrid automatic repeat request (HARQ) identifiers (IDs) from a HARQ buffer associated with the TRP based at least in part on an expiration of the time alignment timer. Numerous other aspects are described.

### FIELD OF THE DISCLOSURE

Aspects of the present disclosure generally relate to wireless communication and to techniques and apparatuses for flushing hybrid automatic repeat request (HARQ) buffers in a multiple transmission reception point (multi-TRP) configuration.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive, from a network entity, a configuration that indicates a time alignment timer associated with a timing advance group (TAG) for a bandwidth part (BWP) or a component carrier (CC) configured for multiple downlink control information (multi-DCI) based multiple transmission reception point (multi-TRP) communications; start the time alignment timer for a TRP; and flush one or more hybrid automatic repeat request (HARQ) identifiers (IDs) from a HARQ buffer associated with the TRP based at least in part on an expiration of the time alignment timer.

In some implementations, a method of wireless communication performed by a UE includes receiving, from a network entity, a configuration that indicates a time alignment timer associated with a TAG for a BWP or a CC configured for multi-DCI based multi-TRP communications; starting the time alignment timer for a TRP; and flushing one or more HARQ IDs from a HARQ buffer associated with the TRP based at least in part on an expiration of the time alignment timer.

In some implementations, a non-transitory computer-readable medium storing a set of instructions for wireless communication includes one or more instructions that, when executed by one or more processors of a UE, cause the UE to: receive, from a network entity, a configuration that indicates a time alignment timer associated with a TAG for a BWP or a CC configured for multi-DCI based multi-TRP communications; start the time alignment timer for a TRP; and flush one or more HARQ IDs from a HARQ buffer associated with the TRP based at least in part on an expiration of the time alignment timer.

In some implementations, an apparatus for wireless communication includes means for receiving, from a network entity, a configuration that indicates a time alignment timer associated with a TAG for a BWP or a CC configured for multi-DCI based multi-TRP communications; means for starting the time alignment timer for a TRP; and means for flushing one or more HARQ IDs from a HARQ buffer associated with the TRP based at least in part on an expiration of the time alignment timer.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment in a wireless network, in accordance with the present disclosure.

FIG. 3 is a diagram illustrating an example of multiple transmission reception point (multi-TRP) operations, in accordance with the present disclosure.

FIG. 4 is a diagram illustrating an example of a timing advance group association, in accordance with the present disclosure.

FIGS. 5-6 are diagrams illustrating examples associated with flushing hybrid automatic repeat request (HARQ) buffers in a multi-TRP configuration, in accordance with the present disclosure.

FIG. 7 is a diagram illustrating an example process associated with flushing HARQ buffers in a multi-TRP configuration, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

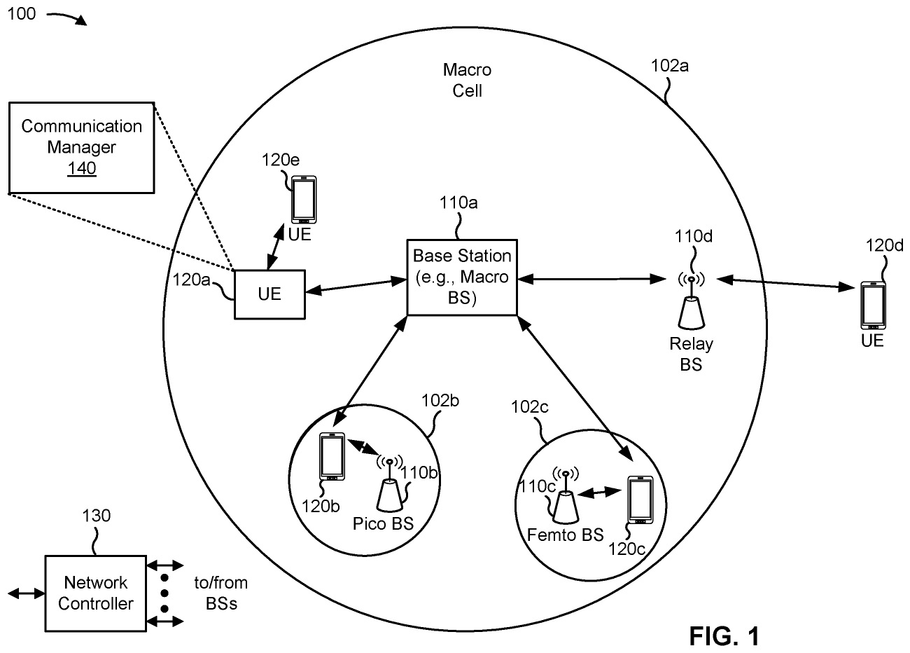

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network entity, a configuration that indicates a time alignment timer associated with a timing advance group (TAG) for a bandwidth part (BWP) or a component carrier (CC) configured for multiple downlink control information (multi-DCI) based multiple transmission reception point (multi-TRP) communications; start the time alignment timer for a TRP; and flush one or more hybrid automatic repeat request (HARQ) identifiers (IDs) from a HARQ buffer associated with the TRP based at least in part on an expiration of the time alignment timer. Additionally, or alternatively, the communication manager 140 may perform one or more other operations described herein.

As indicated above, FIG. 1 is provided as an example. Other examples may differ from what is described with regard to FIG. 1.

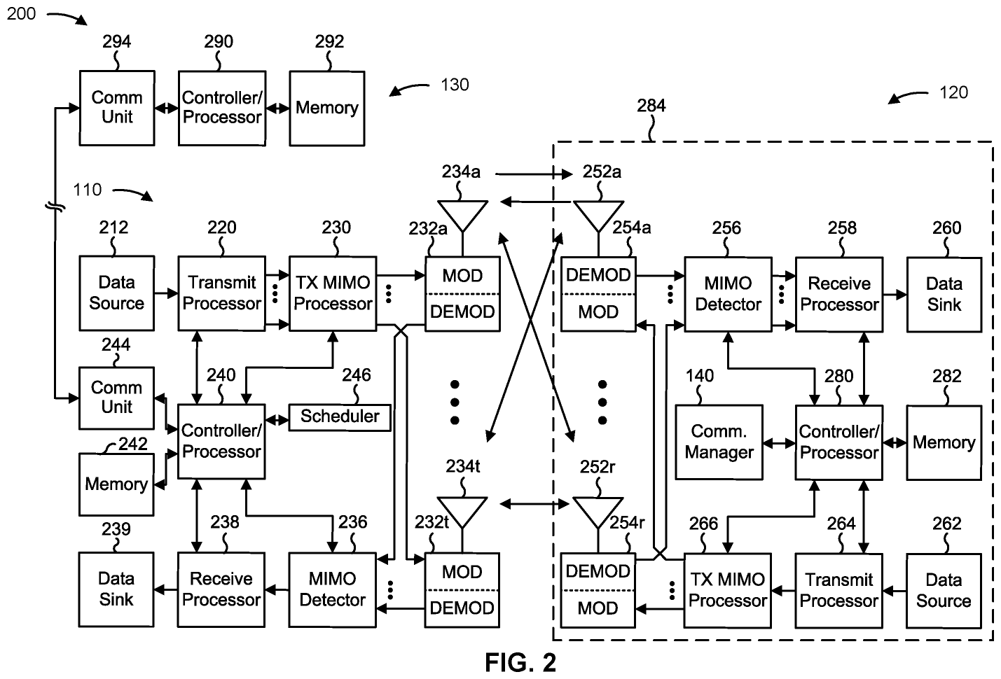

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

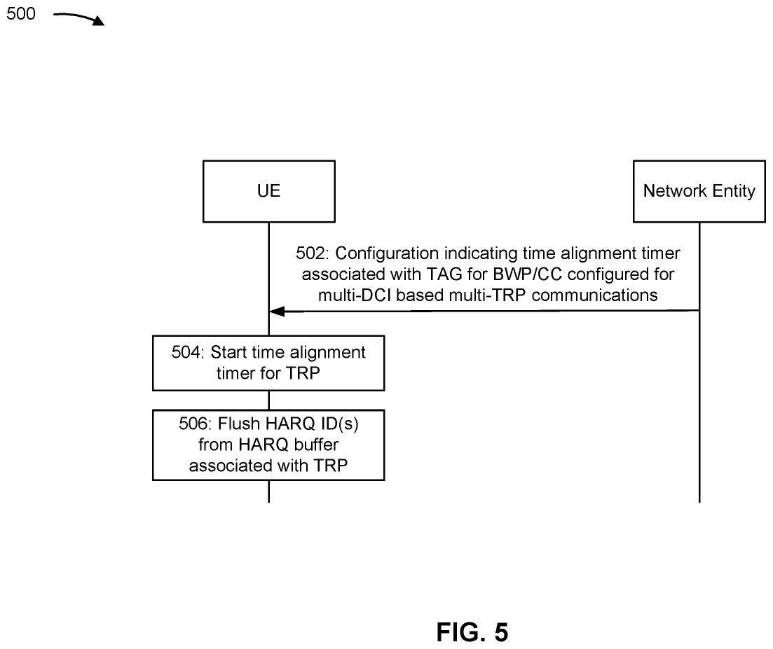

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-8).

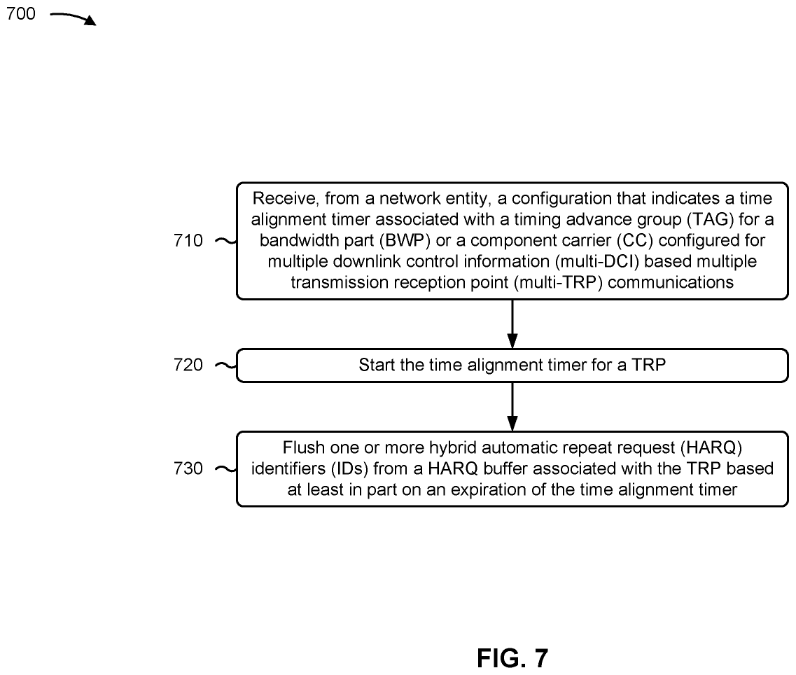

The controller/processor 240 of the base station 110, the controller/processor 280 of the UE 120, and/or any other component(s) of FIG. 2 may perform one or more techniques associated with flushing HARQ buffers in a multi-TRP configuration, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network entity, a configuration that indicates a time alignment timer associated with a TAG for a BWP or a CC configured for multi-DCI based multi-TRP communications; means for starting the time alignment timer for a TRP; and/or means for flushing one or more HARQ IDs from a HARQ buffer associated with the TRP based at least in part on an expiration of the time alignment timer. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Two timing advance (TA) values may be supported for uplink multi-TRP operations. Uplink multi-TRP operations may be scheduled by multiple DCIs. In uplink multi-TRP operations, a first uplink transmission to a first TRP may be scheduled by a first DCI, and a second uplink transmission to a second TRP may be scheduled by a second DCI. Simultaneous uplink transmissions may be associated with multiple panels.

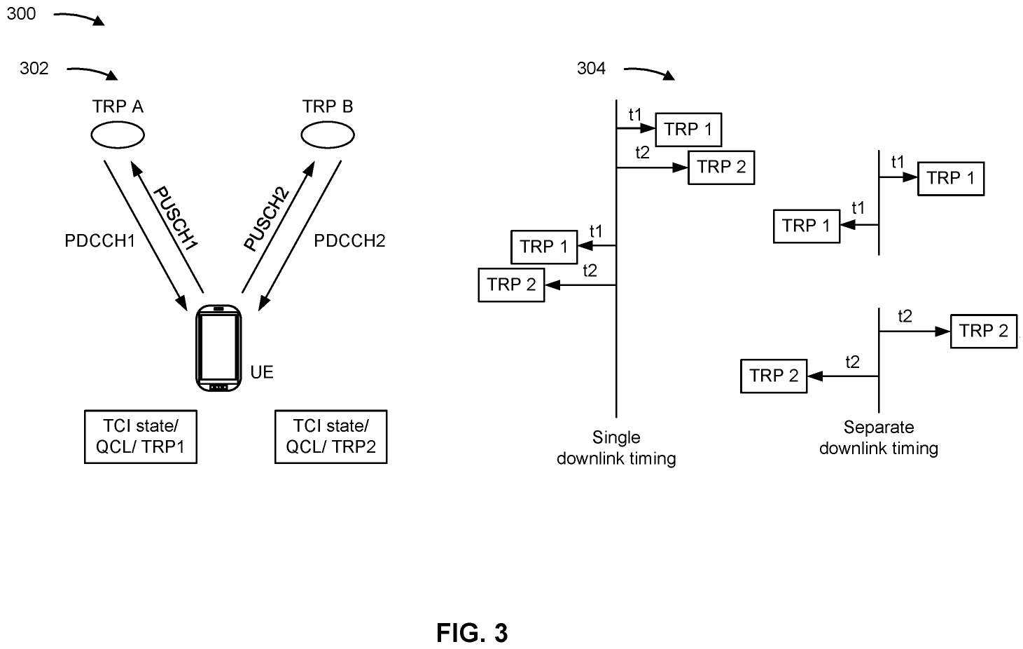

FIG. 3 is a diagram illustrating an example 300 of multi-TRP operations, in accordance with the present disclosure.

As shown by reference number 302, a UE may receive a first physical downlink control channel (PDCCH) from a first TRP. The first TRP may be associated with a first transmission configuration indicator (TCI) or a first quasi-co-location (QCL). The UE may transmit, to the first TRP, a first physical uplink shared channel (PUSCH) based at least in part on the first PDCCH. The UE may receive a second PDCCH from a second TRP. The second TRP may be associated with a second TCI or a second QCL. The UE may transmit, to the second TRP, a second PUSCH based at least in part on the second PDCCH.

As shown by reference number 304, a UE may apply a single downlink timing or a separate downlink timing. The UE may have a TA value per (i.e., for each) TRP. Propagation delays from different TRPs may be different. For an uplink transmission, in order to compensate for a propagation delay, the UE may apply different TA values for the different TRPs. The UE may apply the different TA values for uplink transmissions associated with the different TRPs. For example, when a propagation delay from a first TRP at the UE is t1, the UE may advance uplink transmissions by a value that is based at least in part on t1. As another example, when a propagation delay from a second TRP at the UE is t2, the UE may advance uplink transmissions by a value that is based at least in part on t2.

As indicated above, FIG. 3 is provided as an example. Other examples may differ from what is described with regard to FIG. 3.

A network entity may transmit, to a UE, a TA configuration and a multi-TRP configuration. The TA configuration may be a multi-cell/BWP common configuration. The multi-TRP configuration may be a CC/BWP-specific configuration.

A serving cell configuration may indicate a TAG ID (TAG-Id) and a downlink-BWP-to-add-or-modify-list parameter. The downlink-BWP-to-add-or-modify-list parameter may be associated with a BWP downlink dedicated parameter, which may indicate a control resource set (CORESET) parameter and a CORESET pool index. A TAG may be associated with one or more serving cells with a same uplink TA value and a same downlink timing reference. A serving cell configured with a multi-TRP configuration may also be configured with multiple TAGs, where each TRP may be associated with one TAG.

Different TA values may be associated with different uplink channels or uplink reference signals in a multi-DCI multi-TRP configuration. Two TA values may be associated with different sets of uplink channels or uplink reference signals based at least in part on a high-layer configuration. Different TA values may be based at least in part on TA indications for different TAGs.

A TAG may be associated with a CORESET pool index. For different uplink channels or uplink reference signals, the association may be based at least in part on different types of signaling. In a first example, the association may be based at least in part on a scheduling DCI, e.g., for a dynamic grant (DG) PUSCH or a physical uplink control channel (PUCCH). The scheduling DCI may be associated with a CORESET pool index. In a second example, the association may be based at least in part on activating signaling, such as DCI or a medium access control element (MAC-CE). The activating signaling may be for a semi-persistent (SP) sounding reference signal (SRS), a configured grant (CG) PUSCH, a PUCCH for SP channel state information (CSI), or a semi-persistent scheduling (SPS) physical downlink shared channel (PDSCH). The activating signaling may be transmitted in a PDSCH associated with a CORESET pool index, or may indicate a CORESET pool index. In a third example, the association may be based at least in part on a higher layer configuration, such as a radio resource control (RRC) configuration or a MAC-CE. The higher layer configuration may be for a PUCCH for a periodic CSI (P-CSI) and a periodic SRS (P-SRS).

A TAG may be associated with a closed loop index (CLI) of an uplink channel or an uplink reference signal. A TA value may be based at least in part on the CLI when power control parameters are indicated to the uplink channel or the uplink reference signal. For example, CLIO may be associated with a TA value of a lower TAG-Id, and CLII may be associated with a TA value of a higher TAG-Id.

A TAG may be associated with a unified TCI or a unified TCI group. A serving-cell synchronization signal block (SSB) or a non-serving-cell SSB in a root reference signal of a TCI may be associated with different TA values. As an example, a TCI with a root source reference signal of a serving-cell SSB may be associated with a TA value of a lower TAG-Id, and a TCI with a root source reference signal of a non-serving-cell SSB may be associated with a TA of a higher TAG-Id. As another example, a first half of TCIs in a TCI pool may be associated with a TA of a lower TAG-Id, and a second half of TCIs in the TCI pool may be associated with a TA value of a higher TAG-Id. Further, an association indication may be included in a TCI configuration, a TCI pool configuration, or a TCI activation MAC-CE.

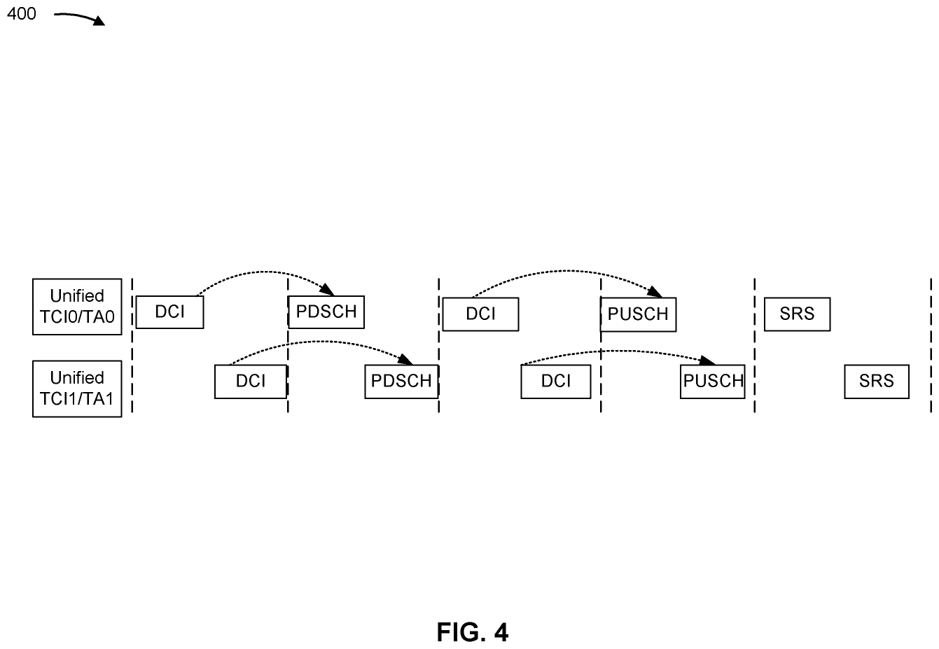

FIG. 4 is a diagram illustrating an example 400 of a TAG association, in accordance with the present disclosure.

As shown in FIG. 4, a first unified TCI (TCI0) or a first TA value (TA0) may be associated with a DCI that schedules a PDSCH, a DCI that schedules a PUSCH, and an SRS. A second unified TCI (TCI1) or a second TA value (TA1) may be associated with a DCI that schedules a PDSCH, a DCI that schedules a PUSCH, and an SRS.

As indicated above, FIG. 4 is provided as an example. Other examples may differ from what is described with regard to FIG. 4.

When a TA command MAC-CE is received, a UE may apply a TA command for an indicated TAG, and the UE may start or restart a time alignment timer associated with the indicated TAG. The time alignment timer may control a time period for which the UE is considered uplink time aligned. When the time alignment timer expires, and when the time alignment timer is associated with a primary timing advance group (PTAG), the UE may flush hybrid automatic repeat request (HARQ) buffers (e.g., clear HARQ IDs associated with HARQ buffers) for a plurality of serving cells. When the time alignment timer is associated with a secondary timing advance group (STAG), for a plurality of serving cells associated with the STAG, the UE may flush a plurality of HARQ buffers.

In some cases, a transport block (TB) with a HARQ ID may be scheduled by any TRP (e.g., a first TRP or a second TRP) in a multi-DCI multi-TRP operation, where the TB with the HARQ ID may be associated with an initial transmission or a retransmission. When a time alignment timer for a TRP expires, the UE may flush a HARQ buffer associated with the TRP. However, since the TB with the HARQ ID may be scheduled by any TRP in the multi-DCI multi-TRP operation, for a given TRP, the UE may not be configured to determine which HARQ IDs should be flushed in the multi-DCI multi-TRP operation.

In various aspects of techniques and apparatuses described herein, a UE may receive, from a network entity, a configuration that indicates a time alignment timer associated with a TAG for a BWP or a CC configured for multi-DCI based multi-TRP communications. The UE may start the time alignment timer for a TRP. The UE may flush one or more HARQ IDs from a HARQ buffer associated with the TRP based at least in part on an expiration of the time alignment timer. The UE may flush HARQ IDs for TBs associated with the TRP in one or more of an initial transmission or a retransmission. As a result, the UE may be able to determine which HARQ IDs are to be flushed or cleared from the HARQ buffer when the UE is configured for multi-DCI based multi-TRP communications.

FIG. 5 is a diagram illustrating an example 500 associated with flushing HARQ buffers in a multi-TRP configuration, in accordance with the present disclosure. As shown in FIG. 5, example 500 includes communication between a UE (e.g., UE 120) and a network entity (e.g., base station 110). In some aspects, the UE and the network entity may be included in a wireless network, such as wireless network 100.

In some aspects, the network entity may be associated with a multi-DCI based multi-TRP configuration. The network entity may be associated with a first TRP and a second TRP based at least in part on the multi-DCI based multi-TRP configuration. The UE may receive multiple DCIs from the first TRP and the second TRP, respectively, and the UE may perform uplink transmissions to the first TRP and the second TRP based at least in part on the multiple DCIs. The first TRP and the second TRP may be associated with multi-DCI based multi-TRP communications.

As shown by reference number 502, the UE may receive, from the network entity, a configuration that indicates a time alignment timer associated with a TAG for a BWP or a CC configured for multi-DCI based multi-TRP communications. The BWP or the CC may be configured for communications with multiple TRPs, such as the first TRP and the second TRP, where the communications may be scheduled using multiple DCIs.

As shown by reference number 504, the UE may start the time alignment timer for a TRP, such as the first TRP or the second TRP. The UE may start the time alignment timer based at least in part on the configuration received from the network entity.

In some aspects, the configuration may indicate a first time alignment timer associated with a first TAG for the BWP or the CC configured for the multi-DCI based multi-TRP communications. The first TAG and the first time alignment timer may be associated with the first TRP. The configuration may indicate a second time alignment timer associated with a second TAG for the BWP or the CC configured for the multi-DCI based multi-TRP communications. The second TAG and the second time alignment timer may be associated with the second TRP.

As shown by reference number 506, the UE may flush one or more HARQ IDs from a HARQ buffer associated with the TRP based at least in part on an expiration of the time alignment timer. For example, after the time alignment timer expires, the UE may flush the one or more HARQ IDs from the HARQ buffer associated with the TRP. When flushing the one or more HARQ IDs, the UE may clear or delete the one or more HARQ IDs from the HARQ buffer. Due to the time alignment timer expiring, storing the one or more HARQ IDs in the HARQ buffer may no longer be needed, so the UE may remove the one or more HARQ IDs from the HARQ buffer. In some aspects, a HARQ may include both downlink HARQs (e.g., HARQs of a PDSCH) and uplink HARQs (e.g., HARQs of a PUSCH). In some aspects, the HARQ may include only downlink HARQs. In some aspects, the HARQ may include only uplink HARQs.

In some aspects, the UE may flush one or more HARQ IDs for one or more TBs associated with the TRP in an initial transmission or a retransmission. In some aspects, the UE may flush one or more HARQ IDs for one or more TBs associated with the TRP in only the initial transmission. In some aspects, the UE may flush one or more HARQ IDs for one or more TBs associated with the TRP in only the retransmission. In some aspects, the UE may flush one or more HARQ IDs for one or more TBs associated with the TRP in both the initial transmission and the retransmission. In some aspects, the UE may flush one or more HARQ IDs for a plurality of TBs irrespective of whether the TBs are associated with the first TRP or the second TRP. In some aspects, the UE may flush no HARQ IDs for one or more TBs associated with the TRP. In some aspects, the UE may flush no HARQ IDs for one or more TBs, where the UE may maintain a plurality of HARQs (e.g., all the HARQs) even after an expiration of a time alignment timer.

In some aspects, the UE may start the first time alignment timer for the first TRP, and the UE may flush one or more HARQ identifiers from a HARQ buffer associated with the first TRP based at least in part on an expiration of the first time alignment timer. Similarly, the UE may start the second time alignment timer for the second TRP, and the UE may flush one or more HARQ identifiers from a HARQ buffer associated with the second TRP based at least in part on an expiration of the second time alignment timer.

In some aspects, two TAGs may be configured with individual time alignment timers in the BWP or the CC configured with the multi-DCI multi-TRP communications. When the time alignment timer for the TRP (e.g., the first TRP or the second TRP) expires, the UE may flush HARQ IDs associated with the TRP whose time alignment timer has expired.

In a first option, when the time alignment timer for the TRP expires, the UE may flush HARQ IDs for any TBs that have been associated with the TRP involved in an initial transmission or a retransmission. In a second option, when the time alignment timer for the TRP expires, the UE may flush HARQ IDs for any TBs that have been associated with the TRP involved in an initial transmission. In a third option, when the time alignment timer for the TRP expires, the UE may flush HARQ IDs for any TBs that have been associated with the TRP involved in a retransmission. In a fourth option, when the time alignment timer for the TRP expires, the UE may flush HARQ IDs for any TBs that have been associated with the TRP involved in both an initial transmission and a retransmission. In a fifth option, when the time alignment timer for the TRP expires, the UE may flush HARQ IDs for a plurality of TBs (e.g., all TBs), regardless of which TRP is associated with the TBs. For example, the UE may flush HARQ IDs for the plurality of TBs, regardless of whether the TBs are associated with the first TRP or the second TRP. In a sixth option, when the time alignment timer for the TRP expires, the UE may flush HARQ IDs for no TBs. The UE may not flush HARQ IDs for any TBs, since these TBs may be scheduled at a later time.

In some aspects, an association between a TB and a TRP (e.g., the first TRP or the second TRP) may be based at least in part on an ID of a CORESET pool index, a CLI, an SRS resource set ID, a TCI ID, and/or a TCI group ID that is associated with the TB. A mapping between an ID (e.g., the ID of the CORESET pool index, the SRS resource set ID, the TCI ID, and/or the TCI group ID) and a TRP ID may be predefined.

As indicated above, FIG. 5 is provided as an example. Other examples may differ from what is described with regard to FIG. 5.

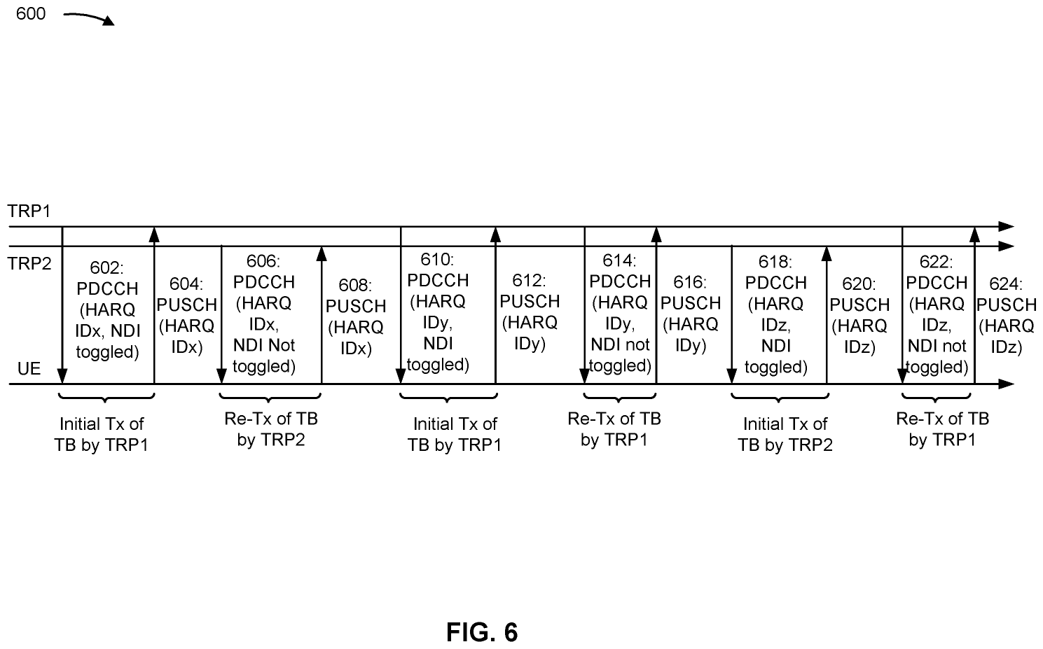

FIG. 6 is a diagram illustrating an example 600 associated with flushing HARQ buffers in a multi-TRP configuration, in accordance with the present disclosure.

As shown by reference number 602, a first TRP may transmit a PDCCH to a UE. The PDCCH may be associated with a HARQ IDx, and a new data indicator (NDI) may be toggled. As shown by reference number 604, the UE may transmit a PUSCH to the first TRP. The PUSCH may be associated with a HARQ IDx. The PDCCH and the PUSCH may be associated with an initial transmission (e.g., a first initial transmission) of a TB by the first TRP.

As shown by reference number 606, a second TRP may transmit a PDCCH to the UE. The PDCCH may be associated with a HARQ IDx, and an NDI may not be toggled. As shown by reference number 608, the UE may transmit a PUSCH to the second TRP. The PUSCH may be associated with a HARQ IDx. The PDCCH and the PUSCH may be associated with a retransmission (e.g., a first retransmission) of a TB by the second TRP.

As shown by reference number 610, the first TRP may transmit a PDCCH to a UE. The PDCCH may be associated with a HARQ IDy, and an NDI may be toggled. As shown by reference number 612, the UE may transmit a PUSCH to the first TRP.

The PUSCH may be associated with a HARQ IDy. The PDCCH and the PUSCH may be associated with an initial transmission (e.g., a second initial transmission) of a TB by the first TRP.

As shown by reference number 614, the first TRP may transmit a PDCCH to a UE. The PDCCH may be associated with a HARQ IDy, and an NDI may be not toggled. As shown by reference number 616, the UE may transmit a PUSCH to the first TRP. The PUSCH may be associated with a HARQ IDy. The PDCCH and the PUSCH may be associated with a retransmission (e.g., a second retransmission) of a TB by the first TRP.

As shown by reference number 618, the second TRP may transmit a PDCCH to a UE. The PDCCH may be associated with a HARQ IDz, and an NDI may be toggled. As shown by reference number 620, the UE may transmit a PUSCH to the second TRP. The PUSCH may be associated with a HARQ IDz. The PDCCH and the PUSCH may be associated with an initial transmission (e.g., a third initial transmission) of a TB by the second TRP.

As shown by reference number 622, the first TRP may transmit a PDCCH to the UE. The PDCCH may be associated with a HARQ IDz, and an NDI may not be toggled. As shown by reference number 624, the UE may transmit a PUSCH to the first TRP. The PUSCH may be associated with a HARQ IDz. The PDCCH and the PUSCH may be associated with a retransmission (e.g., a second retransmission) of a TB by the first TRP.

In some aspects, with respect to FIG. 6, for the first TRP, the UE may flush HARQ IDs from a HARQ buffer of the UE based at least in part on an expiration of a time alignment timer for the first TRP. In a first option, when the UE flushes HARQ IDs for any TBs that have been associated with the first TRP in an initial transmission or a retransmission, the UE may flush HARQ IDx, HARQ IDy, and HARQ IDz from the HARQ buffer. In a second option, when the UE flushes HARQ IDs for any TBs that have been associated with the first TRP in an initial transmission, the UE may flush HARQ IDx and HARQ IDy from the HARQ buffer. In a third option, when the UE flushes HARQ IDs for any TBs that have been associated with the first TRP in a retransmission, the UE may flush HARQ IDy and HARQ IDz from the HARQ buffer. In a fourth option, when the UE flushes HARQ IDs for any TBs that have been associated with the first TRP for both an initial transmission and a retransmission, the UE may flush HARQ IDy from the HARQ buffer. In a fifth option, when the UE flushes HARQ IDs for a plurality of TBs, regardless of whether the TBs are associated with the first TRP or the second TRP, the UE may flush HARQ IDx, HARQ IDy, and HARQ IDz from the HARQ buffer. In a sixth option, when the UE does not flush HARQ IDs for any TBs, the UE may not flush HARQ IDx, HARQ IDy, or HARQ IDz from the HARQ buffer.

In some aspects, with respect to FIG. 6, for the second TRP, the UE may flush HARQ IDs from a HARQ buffer of the UE based at least in part on an expiration of a time alignment timer for the second TRP. In the first option, when the UE flushes HARQ IDs for any TBs that have been associated with the second TRP in an initial transmission or a retransmission, the UE may flush HARQ IDx and HARQ IDz from the HARQ buffer. In the second option, when the UE flushes HARQ IDs for any TBs that have been associated with the second TRP in an initial transmission, the UE may flush HARQ IDz from the HARQ buffer. In the third option, when the UE flushes HARQ IDs for any TBs that have been associated with the second TRP in a retransmission, the UE may flush HARQ IDx from the HARQ buffer.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with flushing HARQ buffers in a multi-TRP configuration.

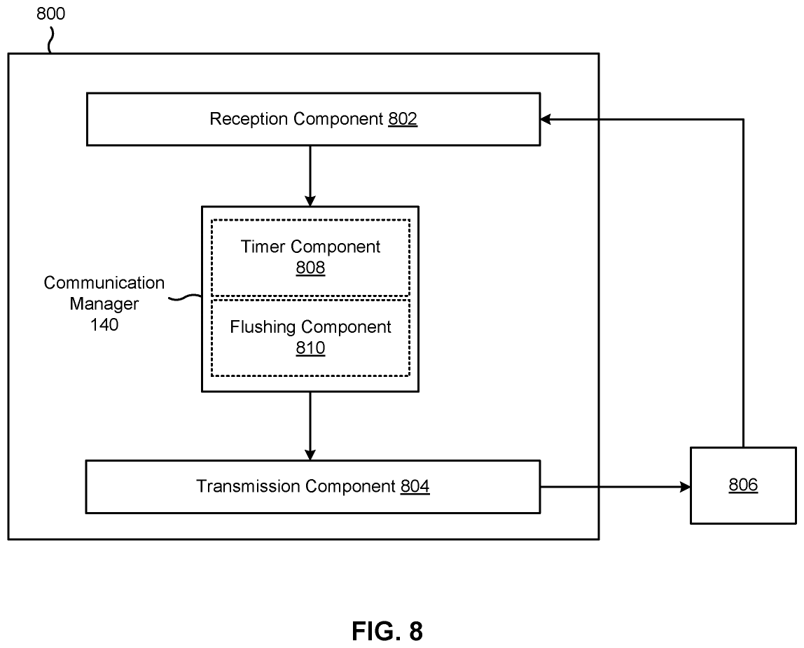

As shown in FIG. 7, in some aspects, process 700 may include receiving, from a network entity, a configuration that indicates a time alignment timer associated with a TAG for a BWP or a CC configured for multi-DCI based multi-TRP communications (block 710). For example, the UE (e.g., using communication manager 140 and/or reception component 802, depicted in FIG. 8) may receive, from a network entity, a configuration that indicates a time alignment timer associated with a TAG for a BWP or a CC configured for multi-DCI based multi-TRP communications, as described above.

As further shown in FIG. 7, in some aspects, process 700 may include starting the time alignment timer for a TRP (block 720). For example, the UE (e.g., using communication manager 140 and/or timer component 808, depicted in FIG. 8) may start the time alignment timer for a TRP, as described above.

As further shown in FIG. 7, in some aspects, process 700 may include flushing one or more HARQ IDs from a HARQ buffer associated with the TRP based at least in part on an expiration of the time alignment timer (block 730). For example, the UE (e.g., using communication manager 140 and/or flushing component 810, depicted in FIG. 8) may flush one or more HARQ IDs from a HARQ buffer associated with the TRP based at least in part on an expiration of the time alignment timer, as described above.

Process 700 may include additional aspects, such as any single aspect or any combination of aspects described below and/or in connection with one or more other processes described elsewhere herein.

In a first aspect, the time alignment timer is a first time alignment timer, the TAG is a first TAG, and the TRP is a first TRP, and the first TAG and the first time alignment timer are associated with the first TRP, and the configuration indicates a second time alignment timer associated with a second TAG for the BWP or the CC configured for multi-DCI based multi-TRP communications, and the second TAG and the second time alignment timer are associated with a second TRP.

In a second aspect, alone or in combination with the first aspect, process 700 includes flushing one or more HARQ IDs for one or more TBs associated with the TRP in an initial transmission or a retransmission.

In a third aspect, alone or in combination with one or more of the first and second aspects, process 700 includes flushing one or more HARQ IDs for one or more TBs associated with the TRP in an initial transmission.

In a fourth aspect, alone or in combination with one or more of the first through third aspects, process 700 includes flushing one or more HARQ IDs for one or more TBs associated with the TRP in a retransmission.

In a fifth aspect, alone or in combination with one or more of the first through fourth aspects, process 700 includes flushing one or more HARQ IDs for one or more TBs associated with the TRP in both an initial transmission and a retransmission.

In a sixth aspect, alone or in combination with one or more of the first through fifth aspects, the TRP is a first TRP, and process 700 includes flushing one or more HARQ IDs for a plurality of TBs irrespective of whether the TBs are associated with the first TRP or a second TRP.

In a seventh aspect, alone or in combination with one or more of the first through sixth aspects, process 700 includes flushing no HARQ IDs for one or more TBs associated with the TRP.

In an eighth aspect, alone or in combination with one or more of the first through seventh aspects, flushing one or more HARQ IDs from the HARQ buffer is based at least in part on a TB associated with the TRP, wherein an association between the TB and the TRP is based at least in part on one or more of an identifier of a CORESET pool index, a CLI, an SRS resource set identifier, a TCI identifier, or a TCI group identifier that is associated with the TB.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a timer component 808, or a flushing component 810, among other examples.

In some aspects, the apparatus 800 may be configured to perform one or more operations described herein in connection with FIGS. 5-6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive, from a network entity, a configuration that indicates a time alignment timer associated with a TAG for a BWP or a CC configured for multi-DCI based multi-TRP communications. The timer component 808 may start the time alignment timer for a TRP. The flushing component 810 may flush one or more HARQ IDs from a HARQ buffer associated with the TRP based at least in part on an expiration of the time alignment timer.

In some aspects, the flushing component 810 may flush one or more HARQ IDs for one or more TBs associated with the TRP in an initial transmission or a retransmission. In some aspects, the flushing component 810 may flush one or more HARQ IDs for one or more TBs associated with the TRP in an initial transmission. In some aspects, the flushing component 810 may flush one or more HARQ IDs for one or more TBs associated with the TRP in a retransmission. In some aspects, the flushing component 810 may flush one or more HARQ IDs for one or more TBs associated with the TRP in both an initial transmission and a retransmission. In some aspects, the flushing component 810 may flush one or more HARQ IDs for a plurality of TBs irrespective of whether the TBs are associated with the first TRP or a second TRP. In some aspects, the flushing component 810 may flush no HARQ IDs for one or more TBs associated with the TRP.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving, from a network entity, a configuration that indicates a time alignment timer associated with a timing advance group (TAG) for a bandwidth part (BWP) or a component carrier (CC) configured for multiple downlink control information (multi-DCI) based multiple transmission reception point (multi-TRP) communications; starting the time alignment timer for a TRP; and flushing one or more hybrid automatic repeat request (HARQ) identifiers (IDs) from a HARQ buffer associated with the TRP based at least in part on an expiration of the time alignment timer.

Aspect 2: The method of Aspect 1, wherein: the time alignment timer is a first time alignment timer, the TAG is a first TAG, and the TRP is a first TRP, and the first TAG and the first time alignment timer are associated with the first TRP; and the configuration indicates a second time alignment timer associated with a second TAG for the BWP or the CC configured for the multi-DCI based multi-TRP communications, and the second TAG and the second time alignment timer are associated with a second TRP.

Aspect 3: The method of any of Aspects 1 through 2, wherein flushing one or more HARQ IDs from the HARQ buffer comprises: flushing one or more HARQ IDs for one or more transport blocks associated with the TRP in an initial transmission or a retransmission.

Aspect 4: The method of any of Aspects 1 through 3, wherein flushing one or more HARQ IDs from the HARQ buffer comprises: flushing one or more HARQ IDs for one or more transport blocks associated with the TRP in an initial transmission.

Aspect 5: The method of any of Aspects 1 through 4, wherein flushing one or more HARQ IDs from the HARQ buffer comprises: flushing one or more HARQ IDs for one or more transport blocks associated with the TRP in a retransmission.

Aspect 6: The method of any of Aspects 1 through 5, wherein flushing the one or more HARQ IDs from the HARQ buffer comprises: flushing one or more HARQ IDs for one or more transport blocks associated with the TRP in both an initial transmission and a retransmission.

Aspect 7: The method of any of Aspects 1 through 6, wherein the TRP is a first TRP, and wherein flushing one or more HARQ IDs from the HARQ buffer comprises: flushing one or more HARQ IDs for a plurality of transport blocks irrespective of whether the transport blocks are associated with the first TRP or a second TRP.

Aspect 8: The method of any of Aspects 1 through 7, wherein flushing one or more HARQ IDs from the HARQ buffer comprises: flushing no HARQ IDs for one or more transport blocks associated with the TRP.

Aspect 9: The method of any of Aspects 1 through 8, wherein flushing one or more HARQ IDs from the HARQ buffer is based at least in part on a transport block associated with the TRP, wherein an association between the transport block and the TRP is based at least in part on one or more of: an identifier of a control resource set pool index, a closed loop index, a sounding reference signal resource set identifier, a transmission configuration indicator identifier, or a transmission configuration indicator group identifier that is associated with the transport block.

Aspect 10: An apparatus for wireless communication at a device, comprising a processor; memory coupled with the processor; and instructions stored in the memory and executable by the processor to cause the apparatus to perform the method of one or more of Aspects 1-9.

Aspect 11: A device for wireless communication, comprising a memory and one or more processors coupled to the memory, the one or more processors configured to perform the method of one or more of Aspects 1-9.

Aspect 12: An apparatus for wireless communication, comprising at least one means for performing the method of one or more of Aspects 1-9.

Aspect 13: A non-transitory computer-readable medium storing code for wireless communication, the code comprising instructions executable by a processor to perform the method of one or more of Aspects 1-9.

Aspect 14: A non-transitory computer-readable medium storing a set of instructions for wireless communication, the set of instructions comprising one or more instructions that, when executed by one or more processors of a device, cause the device to perform the method of one or more of Aspects 1-9.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a network entity, a configuration that indicates a time alignment timer associated with a timing advance group (TAG) for a bandwidth part (BWP) or a component carrier (CC) configured for multiple downlink control information (multi-DCI) based multiple transmission reception point (multi-TRP) communications;
start the time alignment timer for a TRP; and
flush one or more hybrid automatic repeat request (HARQ) identifiers (IDs) from a HARQ buffer associated with the TRP based at least in part on an expiration of the time alignment timer.

2. The apparatus of claim 1, wherein:
the time alignment timer is a first time alignment timer, the TAG is a first TAG, and the TRP is a first TRP, and the first TAG and the first time alignment timer are associated with the first TRP; and
the configuration indicates a second time alignment timer associated with a second TAG for the BWP or the CC configured for the multi-DCI based multi-TRP communications, and the second TAG and the second time alignment timer are associated with a second TRP.

3. The apparatus of claim 1, wherein the one or more processors, to flush one or more HARQ IDs from the HARQ buffer, are configured to:
flush one or more HARQ IDs for one or more transport blocks associated with the TRP in an initial transmission or a retransmission.

4. The apparatus of claim 1, wherein the one or more processors, to flush one or more HARQ IDs from the HARQ buffer, are configured to:
flush one or more HARQ IDs for one or more transport blocks associated with the TRP in an initial transmission.

5. The apparatus of claim 1, wherein the one or more processors, to flush one or more HARQ IDs from the HARQ buffer, are configured to:
flush one or more HARQ IDs for one or more transport blocks associated with the TRP in a retransmission.

6. The apparatus of claim 1, wherein the one or more processors, to flush the one or more HARQ IDs from the HARQ buffer, are configured to:
flush one or more HARQ IDs for one or more transport blocks associated with the TRP in both an initial transmission and a retransmission.

7. The apparatus of claim 1, wherein the TRP is a first TRP, and wherein the one or more processors, to flush the one or more HARQ IDs from the HARQ buffer, are configured to:
flush one or more HARQ IDs for a plurality of transport blocks irrespective of whether the transport blocks are associated with the first TRP or a second TRP.

8. The apparatus of claim 1, wherein the one or more processors, to flush one or more HARQ IDs from the HARQ buffer, are configured to:
flush no HARQ IDs for one or more transport blocks associated with the TRP.

9. The apparatus of claim 1, wherein the one or more processors are configured to flush the one or more HARQ IDs from the HARQ buffer based at least in part on a transport block associated with the TRP, wherein an association between the transport block and the TRP is based at least in part on one or more of: an identifier of a control resource set pool index, a closed loop index, a sounding reference signal resource set identifier, a transmission configuration indicator identifier, or a transmission configuration indicator group identifier that is associated with the transport block.

10. A method of wireless communication performed by a user equipment (UE), comprising:
receiving, from a network entity, a configuration that indicates a time alignment timer associated with a timing advance group (TAG) for a bandwidth part (BWP) or a component carrier (CC) configured for multiple downlink control information (multi-DCI) based multiple transmission reception point (multi-TRP) communications;
starting the time alignment timer for a TRP; and
flushing one or more hybrid automatic repeat request (HARQ) identifiers (IDs) from a HARQ buffer associated with the TRP based at least in part on an expiration of the time alignment timer.

11. The method of claim 10, wherein:
the time alignment timer is a first time alignment timer, the TAG is a first TAG, and the TRP is a first TRP, and the first TAG and the first time alignment timer are associated with the first TRP; and
the configuration indicates a second time alignment timer associated with a second TAG for the BWP or the CC configured for the multi-DCI based multi-TRP communications, and the second TAG and the second time alignment timer are associated with a second TRP.

12. The method of claim 10, wherein flushing one or more HARQ IDs from the HARQ buffer comprises:
flushing one or more HARQ IDs for one or more transport blocks associated with the TRP in an initial transmission or a retransmission.

13. The method of claim 10, wherein flushing one or more HARQ IDs from the HARQ buffer comprises:
flushing one or more HARQ IDs for one or more transport blocks associated with the TRP in an initial transmission.

14. The method of claim 10, wherein flushing one or more HARQ IDs from the HARQ buffer comprises:
flushing one or more HARQ IDs for one or more transport blocks associated with the TRP in a retransmission.

15. The method of claim 10, wherein flushing the one or more HARQ IDs from the HARQ buffer comprises:
flushing one or more HARQ IDs for one or more transport blocks associated with the TRP in both an initial transmission and a retransmission.

16. The method of claim 10, wherein the TRP is a first TRP, and wherein flushing one or more HARQ IDs from the HARQ buffer comprises:
flushing one or more HARQ IDs for a plurality of transport blocks irrespective of whether the transport blocks are associated with the first TRP or a second TRP.

17. The method of claim 10, wherein flushing one or more HARQ IDs from the HARQ buffer comprises:
flushing no HARQ IDs for one or more transport blocks associated with the TRP.

18. The method of claim 10, wherein flushing one or more HARQ IDs from the HARQ buffer is based at least in part on a transport block associated with the TRP, wherein an association between the transport block and the TRP is based at least in part on one or more of: an identifier of a control resource set pool index, a closed loop index, a sounding reference signal resource set identifier, a transmission configuration indicator identifier, or a transmission configuration indicator group identifier that is associated with the transport block.

19. A non-transitory computer-readable medium storing a set of instructions for wireless communication, the set of instructions comprising:
one or more instructions that, when executed by one or more processors of a user equipment (UE), cause the UE to:
receive, from a network entity, a configuration that indicates a time alignment timer associated with a timing advance group (TAG) for a bandwidth part (BWP) or a component carrier (CC) configured for multiple downlink control information (multi-DCI) based multiple transmission reception point (multi-TRP) communications;
start the time alignment timer for a TRP; and
flush one or more hybrid automatic repeat request (HARQ) identifiers (IDs) from a HARQ buffer associated with the TRP based at least in part on an expiration of the time alignment timer.

20. The non-transitory computer-readable medium of claim 19, wherein:
the time alignment timer is a first time alignment timer, the TAG is a first TAG, and the TRP is a first TRP, and the first TAG and the first time alignment timer are associated with the first TRP; and
the configuration indicates a second time alignment timer associated with a second TAG for the BWP or the CC configured for the multi-DCI based multi-TRP communications, and the second TAG and the second time alignment timer are associated with a second TRP.

21. The non-transitory computer-readable medium of claim 19, wherein the one or more instructions, that cause the UE to flush one or more HARQ IDs from the HARQ buffer, cause the UE to:
flush one or more HARQ IDs for one or more transport blocks associated with the TRP in an initial transmission or a retransmission.

22. The non-transitory computer-readable medium of claim 19, wherein the one or more instructions, that cause the UE to flush one or more HARQ IDs from the HARQ buffer, cause the UE to:
flush one or more HARQ IDs for one or more transport blocks associated with the TRP in an initial transmission.

23. The non-transitory computer-readable medium of claim 19, wherein the one or more instructions, that cause the UE to flush one or more HARQ IDs from the HARQ buffer, cause the UE to:
flush one or more HARQ IDs for one or more transport blocks associated with the TRP in a retransmission.

24. The non-transitory computer-readable medium of claim 19, wherein the one or more instructions, that cause the UE to flush the one or more HARQ IDs from the HARQ buffer, cause the UE to:
flush one or more HARQ IDs for one or more transport blocks associated with the TRP in both an initial transmission and a retransmission.

25. An apparatus for wireless communication, comprising:
means for receiving, from a network entity, a configuration that indicates a time alignment timer associated with a timing advance group (TAG) for a bandwidth part (BWP) or a component carrier (CC) configured for multiple downlink control information (multi-DCI) based multiple transmission reception point (multi-TRP) communications;
means for starting the time alignment timer for a TRP; and
means for flushing one or more hybrid automatic repeat request (HARQ) identifiers (IDs) from a HARQ buffer associated with the TRP based at least in part on an expiration of the time alignment timer.

26. The apparatus of claim 25, wherein:
the time alignment timer is a first time alignment timer, the TAG is a first TAG, and the TRP is a first TRP, and the first TAG and the first time alignment timer are associated with the first TRP; and
the configuration indicates a second time alignment timer associated with a second TAG for the BWP or the CC configured for the multi-DCI based multi-TRP communications, and the second TAG and the second time alignment timer are associated with a second TRP.

27. The apparatus of claim 25, wherein the means for flushing one or more HARQ IDs from the HARQ buffer comprises:
means for flushing one or more HARQ IDs for one or more transport blocks associated with the TRP in an initial transmission or a retransmission.

28. The apparatus of claim 25, wherein the means for flushing one or more HARQ IDs from the HARQ buffer comprises:
means for flushing one or more HARQ IDs for one or more transport blocks associated with the TRP in an initial transmission.

29. The apparatus of claim 25, wherein the means for flushing one or more HARQ IDs from the HARQ buffer comprises:
means for flushing one or more HARQ IDs for one or more transport blocks associated with the TRP in a retransmission.

30. The apparatus of claim 25, wherein the means for flushing the one or more HARQ IDs from the HARQ buffer comprises:
means for flushing one or more HARQ IDs for one or more transport blocks associated with the TRP in both an initial transmission and a retransmission.
